(19) United States
(12) Patent Application Publication
(10) Pub. No.: US 2004/0183900 A1
(43) Pub. Date: Sep. 23, 2004

(54) Method and system for automatically detecting defects in remote video inspection applications

(75) Inventors: Thomas Karpen, Skaneateles, NY (US); Clark Bendall, Syracuse, NY (US); Jon R. Salvati, Skaneateles, NY (US)

Correspondence Address: WALL MARJAMA & BILINSKI, 101 SOUTH SALINA STREET, SUITE 400, SYRACUSE, NY, 13202, US

(73) Assignee: Everest VIT

(21) Appl. No.: 10/393,341

(22) Filed: Mar. 20, 2003

(51) Int. Cl. H04N 7/18

(52) U.S. Cl. 348/92; 348/86

(57) ABSTRACT

The system automatically performs analysis on images from a remote video inspection apparatus to provide an operator with an indication of areas that are potentially out of specification, or which require more detailed analysis by the operator. Pattern recognition algorithms are applied to sequential images to search for anomalies or defects in the images. The search area is initially limited to edges of the item being inspected where the probability of defects is much higher. To reduce the processing requirements and probability of false detection, the search area is narrowed to a limited field of view and depth. Defects such as dents and small cracks are detected using stereo measurement techniques or by projecting a known supplementary image into the defect. These techniques are used to provide an image disparity map. Using known triangulation algorithms, this map provides depth and distance information to the processing system.

### FIELD OF THE INVENTION

This invention relates generally to the field of remote video inspection, and more particularly to a method and system for automatically detecting defects in an object inspected by a remote visual device.

### BACKGROUND OF THE INVENTION

Remote video inspection (RVI) requires a user to inspect for defects. These defects can be small and at times are difficult to see. In some applications, such as the inspection of aircraft or power generation gas turbine engine blades, the user is required to visually inspect several turbine blades in an operation that is repetitive. As a result, defects can be missed, and the safety of the engine can be compromised.

Gas turbine engines contain several user removable inspection access ports. These ports provide access to critical areas of the engine with a remote visual device, such as an endoscope or borescope. The engines being inspected typically have multiple stages, each of which has many blades that must be inspected.

In a typical inspection, the end of the probe is held stationary in a position which gives a clear view of a specific section of the blades of a given stage. The engine is then rotated so that each blade in the stage passes in front of the probe while the inspector watches a monitor for signs of damage to the blade. The user views the images and searches for defects such as cracks, missing or deformed material, dents, the distance of the blade tip to the engine shroud, and others. Several passes are typically required for each stage. The inspection involves a very repetitive process often performed late at night under a tight schedule, all of which increase the risk of a defect going undetected.

### SUMMARY OF THE INVENTION

Briefly stated, the system automatically performs analysis on images from a remote video inspection apparatus to provide an operator with an indication of areas that are potentially out of specification, or which require more detailed analysis by the operator. Pattern recognition algorithms are applied to sequential images to search for anomalies or defects in the images. The search area is initially limited to edges of the item being inspected where the probability of defects is much higher. To reduce the processing requirements and probability of false detection, the search area is narrowed to a limited field of view and depth. Defects such as dents and small cracks are detected using stereo measurement techniques. These techniques are used to provide an image disparity map. Using known triangulation algorithms, this map provides depth and distance information to the processing system.

According to an embodiment of the invention, an industrial video inspection system for detecting a possible defect includes acquisition means for acquiring an image of a portion of a rotating object; and detection means for detecting any non-planar features and any non-smoothly curving features which are indicative of said possible defect in said portion of said rotating object.

According to an embodiment of the invention, an industrial video inspection system for detecting a possible defect includes acquisition means for acquiring at least first and second successive images of a portion of a rotating object; comparison means for comparing said at least first and second successive images to each other; and detection means for detecting any differences between said first and second successive images to detect said possible defect.

According to an embodiment of the invention, a method for detecting a possible defect includes the steps of: (a) acquiring an image of a portion of a rotating object; and (b) detecting any non-planar features and any non-smoothly curving features which are indicative of said possible defect in said portion of said rotating object.

According to an embodiment of the invention, a method for inspecting an industrial video inspection system to detect a possible defect includes the steps of: (a) acquiring at least first and second successive images of a portion of a rotating object; (b) comparing said at least first and second successive images to each other; and (c) detecting any differences between said first and second successive images to detect said possible defect.

### BRIEF DESCRIPTION OF THE DRAWINGS

FIG. 1 shows a jet engine turbine used to explain an embodiment of the present invention;

FIG. 2 shows a defect on a blade of a jet engine turbine;

FIG. 3 shows a leading edge of a blade of a jet engine turbine with a defect on it;

FIG. 3 shows a leading edge of a blade of a jet engine turbine with a defect on it;

FIG. 4 shows a block diagram of a system according to an embodiment of the present invention; and

FIG. 5 shows a flow chart of a method according to an embodiment of the present invention.

### DETAILED DESCRIPTION OF THE INVENTION

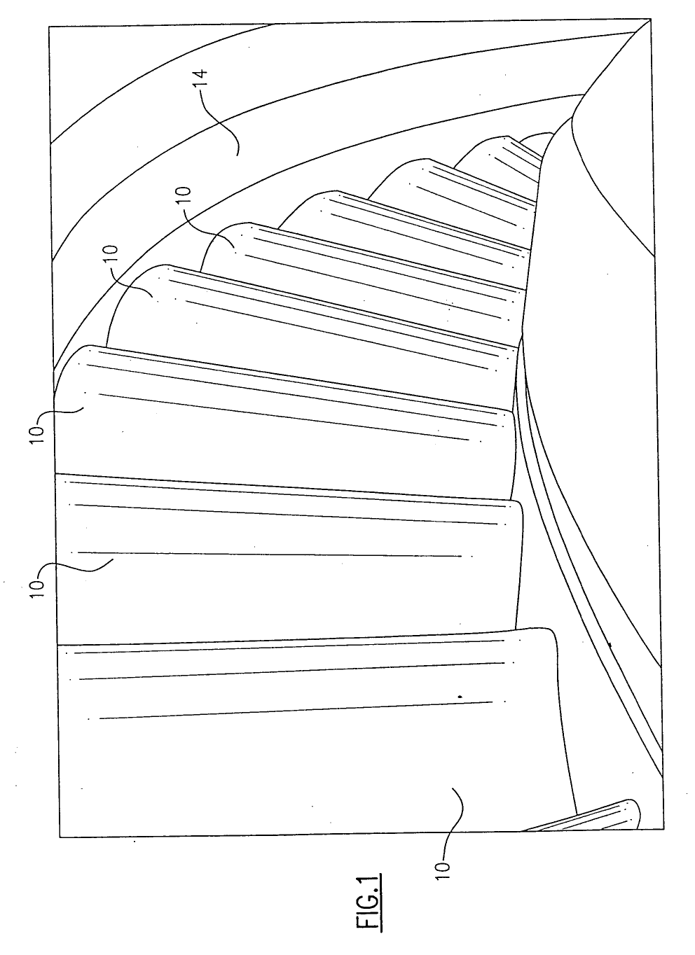

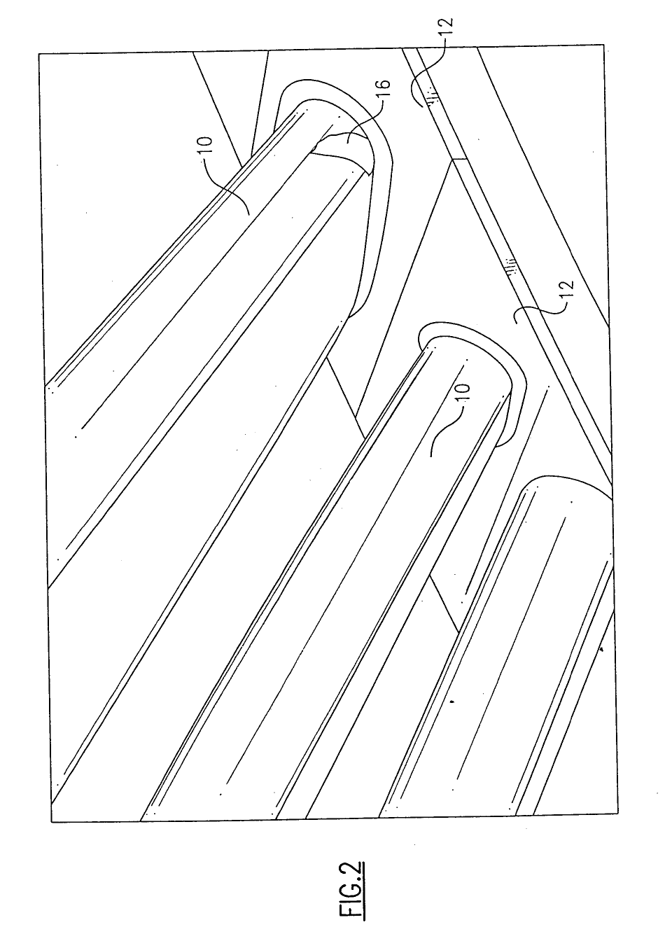

Referring to FIGS. 1-2, a plurality of blades 10 are affixed to a corresponding blade base 12. In a typical gas turbine engine, blade bases 12 are affixed to a rotating shaft (not shown). A housing 14 surrounds blades 10. A possible defect 16 near one blade base 12 of one blade 10 is shown in FIG. 2.

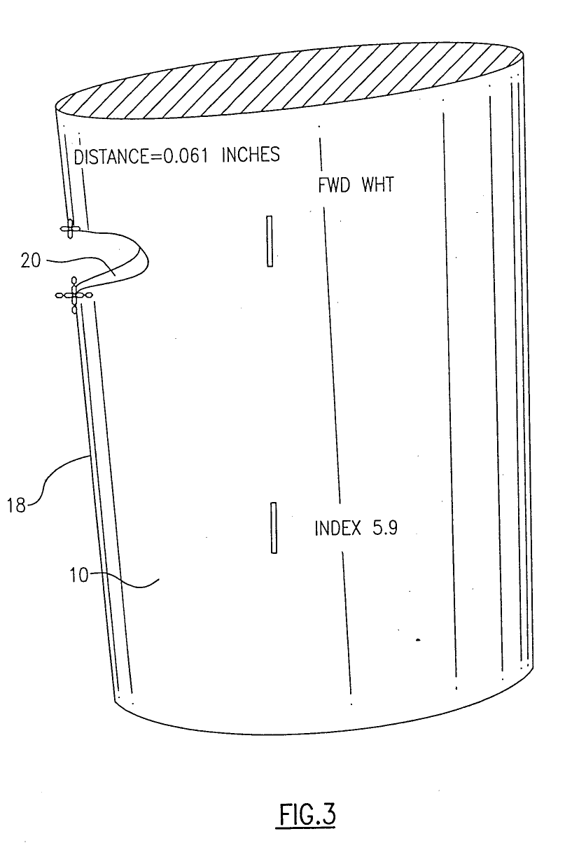

Referring to FIG. 3, a leading edge 18 of one blade 10 has a defect 20 in it, specifically a chip. Turbine blade defects generally fall into one of four categories: (a) cracks at the base, i.e., where blade 10 meets blade base 12, (b) chips in the blade edge, as with defect 20, (c) chips in the outer corners, and (d) dents in the surfaces. The first three categories present the most serious safety risk, so are therefore of the greatest interest. Possible defect 16 falls into category (a), i.e., a possible crack at the base.

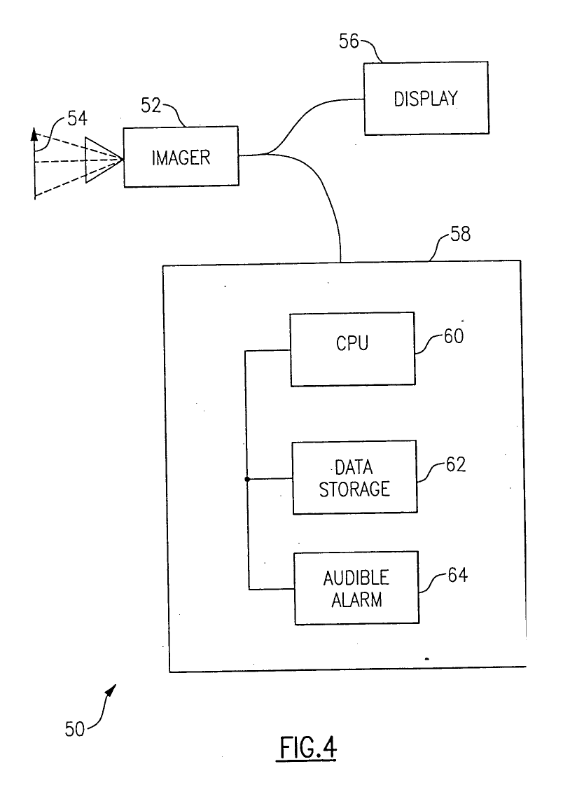

Referring to FIG. 4, a remote visual device, such as an endoscope or borescope 50, includes an imager 52 which images an object 54 and displays the image on a display 56. The image is also sent to a main body 58 which contains a processor such as a CPU 60 and a data storage device 62. The display 56 can be in the same unit as the imager 52 wherein the image of object 54 can be sent directly to CPU 60 for processing before being displayed on display 56. Data storage 62 such as ROM, RAM, CD-ROM, hard disk, or any other optical or magnetic media can be used for short or long term data storage. Audible alarms such as alarm 64 are further provided. The present invention is preferably embodied in software contained in data storage 62 or CPU 60, but embodiments in firmware and hardware are also possible.

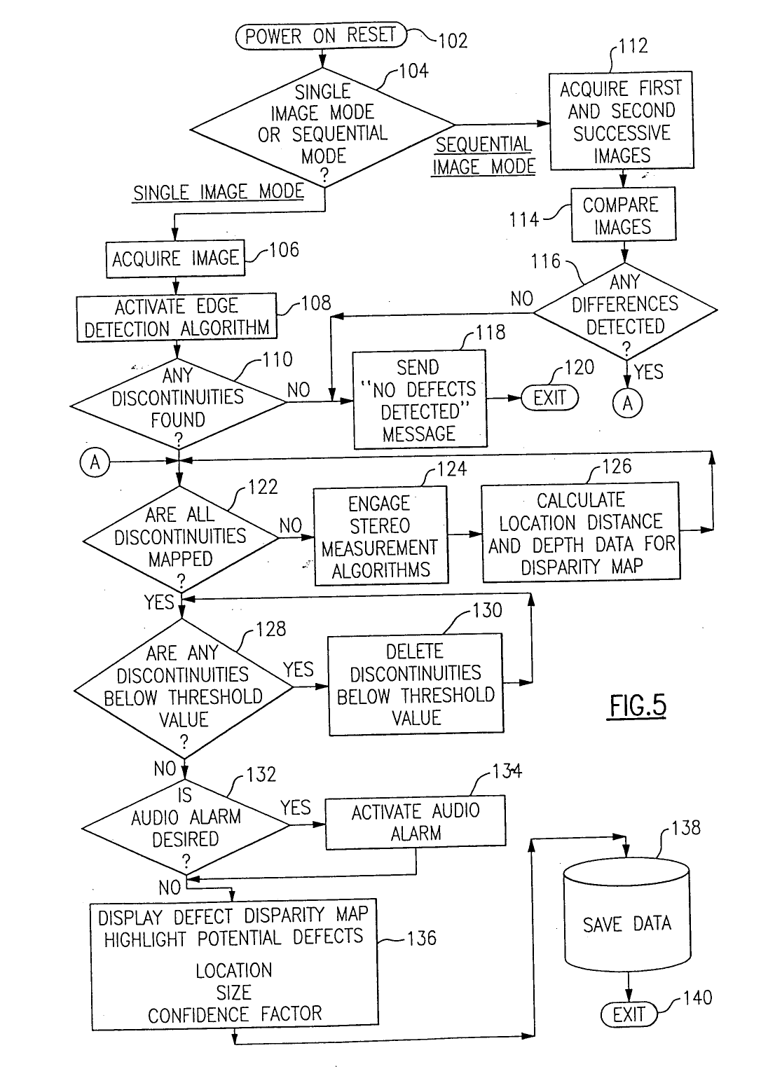

Referring to FIG. 5, a method of the present invention is shown. In step 102, the system is powered on and all values are reset. In step 104, the user is asked to select either a single image mode or a sequential mode. If single image mode is selected, the image is acquired in step 106, after which the edge detection algorithm is activated in step 108. If no discontinuities are found during the inspection, a “no defects detected” message is preferably sent to the user in step 118, after which the system stops in step 120. If discontinuities are found, the system goes to step 122.

If the user selects the sequential image mode in step 104, the first and second successive images are acquired in step 112. The images are then compared in step 114 to see if there are any differences between the images. This technique is based on the assumption that if a number of identical units are being inspected, any difference between units (images) is likely the result of a defect in one of the units. Alternately, one of the images in the sequential mode may be a reference image. This reference image may be a saved image of an identical unit or an image from a maintenance manual or library. If no differences are detected in step 116, the “no defects detected” message is preferably sent to the user in step 118, after which the system stops in step 120. If differences are detected, the system goes to step 122.

In step 122, the system checks to see if all discontinuities are mapped, and if not, at least one measurement algorithm is engaged in step 124. This measurement algorithm(s) may be based on stereo measurement techniques, if the imaging system is stereoscopic. Alternately, a known supplementary image is projected into the defect, as described in U.S. Pat. No. 5,070,401. In step 126, the location, distance, and depth data for a disparity map are calculated, after which the system goes back to step 122. Once all discontinuities are mapped, the system checks, in step 128, to see if there are any discontinuities below the threshold value, and if so; they are deleted in step 130. Once all discontinuities below the threshold value are deleted, the system checks to determine if the user has specified a desire for an audio alarm in step 132, and if yes, the audio alarm is activated in step 134. If no audio alarm is desired, the system preferably displays the defect disparity map in step 136, preferably highlighting potential defects by their location, size, and confidence factor. The data are saved in step 138, after which the system stops in step 140.

The edge detection algorithm of step 108 preferably uses pattern recognition techniques to automatically search for and highlight defects on the turbine blades to improve the likelihood of finding all defects. The system automatically performs analysis on the images to provide an operator with an indication of areas that are potentially out of specification, or require more detailed analysis by the operator. Pattern recognition algorithms are applied to sequential images to search for anomalies or defects in the images. The search area is initially limited to the edges of the blades where the probability of defects is much higher. To reduce the processing requirements and probability of false detection, the search area is narrowed to a limited field of view and depth. Defects such as dents and small cracks are detected using stereo measurement techniques, or by projecting a known supplementary image into the defect, as described in U.S. Pat. No. 5,070,401 (Salvati et al.), the entire contents of which are herein incorporated by reference. These techniques are preferably used to provide an image disparity map. Using known triangulation algorithms, this map provides depth and distance information to the processing system.

The output of this system is preferably an indication to the user, such as a highlighted area on the image displayed on display 56 or an audio beep from audible alarm 64. The size or location of the defect is also preferably be provided.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

We claim:

1. An industrial video inspection system for detecting a possible defect, comprising:
acquisition means for acquiring an image of a portion of a rotating object; and
detection means for detecting any non-planar features and any non-smoothly curving features which are indicative of said possible defect in said portion of said rotating object.

2. A system according to claim 1, further comprising indication means, responsive to said detection means, for indicating said features detected to a user.

3. A system according to claim 2, further comprising measuring means for measuring said detected features indicative of said possible defect to obtain a measurement result and providing said measurement result to said user.

4. A system according to claim 3, wherein said measurement result includes a location and size of said feature, and said measurement result is used to prepare a disparity map for said user.

5. A system according to claim 4, wherein said detection means includes means for determining a confidence factor for said feature.

6. A system according to claim 4, further comprising data storage means for storing said disparity map in said system.

7. A system according to claim 2, wherein said indication means includes a display.

8. A system according to claim 2, wherein said indication means includes an audible signal.

9. A system according to claim 1, wherein said detection means analyzes edges of said object for discontinuities that are potential defects.

10. A system according to claim 1, further comprising selection means for enabling a user to select a specific field of view and/or a specific depth of view for said acquisition means.

11. A system according to claim 1, further comprising measuring means for measuring said detected features indicative of said possible defect to obtain a measurement result and providing said measurement result to a user.

12. A system according to claim 11, wherein said measurement result includes a location and size of said feature.

13. A system according to claim 1, further comprising threshold specification means for enabling a user to set a threshold for said features within said detection means.

14. An industrial video inspection system for detecting a possible defect, comprising:
acquisition means for acquiring at least first and second successive images of a portion of a rotating object;
comparison means for comparing said at least first and second successive images to each other; and
detection means for detecting any differences between said first and second successive images to detect said possible defect.

15. An industrial video inspection system according to claim 14, wherein at least one of the successive images is a previously saved image or a reference image.

16. An industrial video inspection system according to claim 14, further comprising indication means, responsive to said detection means, for indicating said differences between said first and second successive images to a user.

17. A system according to claim 16, further comprising measuring means for measuring said detected features indicative of said possible defect to obtain a measurement result and providing said measurement result to said user.

18. A system according to claim 17, wherein said measurement result includes a location and size of said feature, and said measurement result is used to prepare a disparity map for said user.

19. A system according to claim 18, wherein said detection means includes means for determining a confidence factor for said feature.

20. A system according to claim 18, further comprising data storage means for storing said disparity map in said system.

21. A system according to claim 16, wherein said indication means includes a display.

22. A system according to claim 16, wherein said indication means includes an audible signal.

23. A system according to claim 14, wherein said detection means analyzes edges of said object for discontinuities that are potential defects.

24. A system according to claim 14, further comprising selection means for enabling a user to select a specific field of view and/or a specific depth of view for said acquisition means.

25. A system according to claim 14, further comprising measuring means for measuring said detected features indicative of said possible defect to obtain a measurement result and providing said measurement result to a user.

26. A system according to claim 25, wherein said measurement result includes a location and size of said feature.

27. A system according to claim 14, further comprising threshold specification means for enabling a user to set a threshold for said features within said detection means.

28. A method for detecting a possible defect, comprising the steps of:
acquiring an image of a portion of a rotating object; and
detecting any non-planar features and any non-smoothly curving features which are indicative of said possible defect in said portion of said rotating object.

29. A method according to claim 28, further comprising the step of indicating said features detected to a user.

30. A method according to claim 29, further comprising the step of measuring said detected features indicative of said possible defect to obtain a measurement result and providing said measurement result to said user.

31. A method according to claim 30, wherein said measurement result includes a location and size of said feature, and further comprising the step of preparing a disparity map for said user based on said measurement result.

32. A method according to claim 31, wherein said step of detecting includes the step of determining a confidence factor for said feature.

33. A method according to claim 31, further comprising the step of storing said disparity map in said system.

34. A method according to claim 29, wherein said step of indicating includes displaying said features on a display.

35. A method according to claim 29, wherein said step of indicating includes sounding a signal audible to said user.

36. A method according to claim 28, wherein said step of detecting analyzes edges of said object for discontinuities that are potential defects.

37. A method according to claim 28, further comprising the step of enabling a user to select a specific field of view and/or a specific depth of view for said step of acquiring.

38. A method according to claim 28, further comprising the step of measuring said detected features indicative of said possible defect to obtain a measurement result and providing said measurement result to a user.

39. A method according to claim 38, wherein said measurement result includes a location and size of said feature.

40. A method according to claim 27, further comprising enabling a user to set a threshold for said features within said step of detecting.

41. A method for inspecting an industrial video inspection system to detect a possible defect, comprising the steps of:
acquiring at least first and second successive images of a portion of a rotating object;
comparing said at least first and second successive images to each other; and
detecting any differences between said first and second successive images to detect said possible defect.

42. A method according to claim 40, wherein at least one of the successive images is a previously saved image or a reference image.

43. A method according to claim 41, further comprising the step of, in conjunction with said step of detecting, indicating said differences between said first and second successive images to a user.

44. A method according to claim 44, further comprising the steps of:
measuring said detected features indicative of said possible defect to obtain a measurement result; and
providing said measurement result to said user.

45. A method according to claim 44, wherein said measurement result includes a location and size of said feature, and further comprising the step of preparing a disparity map for said user based on said measurement result.

46. A method according to claim 45, wherein said step of detecting includes the step of determining a confidence factor for said feature.

47. A method according to claim 45, further comprising the step of storing said disparity map in said system.

48. A method according to claim 43, wherein said step of indicating includes the step of displaying said possible defect on a display.

49. A method according to claim 43, wherein said step of indicating includes the step of sounding a signal audible to said user.

50. A method according to claim 41, wherein said step of detecting analyzes edges of said object for discontinuities that are potential defects.

51. A method according to claim 41, further comprising the step of enabling a user to select a specific field of view and/or a specific depth of view for said step of acquiring.

52. A method according to claim 41, further comprising the steps of:
measuring said detected features indicative of said possible defect to obtain a measurement result; and
providing said measurement result to a user.

53. A method according to claim 52, wherein said measurement result includes a location and size of said feature.

54. A method according to claim 41, further comprising the step of enabling a user to set a threshold for said features within said detection means.
